(19) United States
(12) Patent Application Publication
(10) Pub. No.: US 2025/0341240 A1
(43) Pub. Date: Nov. 6, 2025

(54) BRAKE PAD DEMONSTRATING IMPROVED PERFORMANCE

(71) Applicants: Beringer Aero, Tallard (FR); Beringer, Saint Jean D'Ardieres (FR)

(72) Inventor: Gilbert Beringer, Fouillouse (FR)

(73) Assignees: Beringer Aero, Tallard (FR); Beringer, Saint Jean D'Ardieres (FR)

(21) Appl. No.: 18/832,369

(22) PCT Filed: Oct. 20, 2022
(86) PCT No.: PCT/FR2022/051991

§ 371 Date: Jan. 15, 2025

(30) Foreign Application Priority Data
Jan. 31, 2022 (FR) FR2200826

(51) Int. Cl. F16D 65/095; F16D 55/00; F16D 65/00

(52) U.S. Cl. CPC F16D 65/095; F16D 55/00; F16D 65/0068; F16D 2055/0016; F16D 2200/0021; F16D 2200/0052

(57) ABSTRACT

The invention relates to a brake pad or a disc brake caliper, comprising a support plate receiving a friction material. According to the invention, the support plate is made from low-alloy carbon steel containing less than 0.3% by weight of carbon and vanadium in an amount between 0.2 and 0.3% by weight.

### TECHNICAL FIELD

The invention relates to the technical field of disc brakes, and more particularly to the pads used in such brakes.

### BACKGROUND ART

In the field of disc brakes, the braking effort is directly related to parameters such as:
The material of the pads;
The material of the disc;
The surface area of the friction zone between the pads and the disc;
The clamping force of the pads on the disc.

Braking performance is linked, among other things, to:
The obtainable braking effort;
Kinetic parameters, such as the rotational speed of the disc, the kinetic energy of the vehicle equipped with the brake, and particularly the kinetic energy to be dissipated during each braking;
The frequency of brake use over time;
The thermal parameters of the brake, notably its ability to resist the heat generated during the conversion of kinetic energy into thermal energy, or to dissipate this heat.

The brake pad is a wear part, and its replacement should be easy. Therefore, its installation, particularly the kinematic connection to the caliper, should be as simple as possible. This connection is generally minimalistic, ensured by the smallest and simplest possible functional surfaces.

These functional surfaces, which withstand the braking effort, are generally subject to deformation or the backing plate of the pads can bend. To prevent this, it is often necessary to oversize the pads, particularly their backing plates.

Moreover, repeated or intensive braking leads to a significant increase in the temperature of the pad and disc, which can reach temperatures above 700° C. This is the case when such a brake is used in motor sports, such as motorcycle racing, or in aviation for aircraft landing gear, especially light aircraft. The temperature rise can be particularly rapid, in just a few seconds. Therefore, besides its mechanical strength, the pad must have excellent resistance to thermal stresses.

Furthermore, there is a constant effort to reduce the weight of onboard parts. Therefore, there is a contradiction between the need for a strong pad and one that remains lightweight.

Solutions for lightweight brake pads are known from documents WO2019106805A1 and US20110198170A1.

Brake discs made from highly alloyed materials are known from document US20060113008A1.

The article “Les Matériaux De Freinage” by Jacques RAISON, published in the July/August 1991 issue of La Revue Générale Des Chemins De Fer, is also known.

### SUMMARY OF THE INVENTION

One of the objectives of the invention is to overcome the disadvantages of the prior art by proposing a lightweight and strong brake pad for a disc brake caliper.

To this end, a brake pad for a disc brake caliper has been developed, comprising a support plate receiving a friction material.

According to the invention, the support plate is made from low-alloy steel containing less than 0.3% by weight of carbon, preferably less than 0.2%, and vanadium in an amount between 0.2 and 0.3% by weight, with the remainder preferably being iron with reasonably foreseeable impurities. The plate is, for example, made from 15CDV6 steel.

This steel grade, typically intended for welded parts, allows for the creation of a pad with sufficient mechanical and thermal properties to achieve a lightweight and strong pad. The presence of vanadium notably improves the plate's hot strength.

This particular choice of steel grade allows for the creation of a support plate with a thickness of only 2 to 6 mm, which helps to lighten the pad.

The plate includes kinematic connection means with a brake caliper. In practice, to prevent the pad from deforming even at high temperatures, part of these connection means is configured to withstand higher mechanical forces than the rest of the connection means, forming a reinforced portion. The other part is lightened.

In a first embodiment, the support plate has a first lug of a first diameter and a second lug of a second larger diameter. Each lug is configured to cooperate respectively with a first and a second caliper bushing, forming a sliding connection between the pad and the caliper. The reinforced portion is the second lug. Since the surface of the second lug transmitting the forces is larger, the contact pressure is lower, preventing deformation.

The invention also relates to a caliper comprising a first bushing of a first diameter and length, and a second bushing of a different diameter and length, connecting the caliper's two jaws. The caliper receives pads with a support plate featuring a first lug of the first diameter and a second lug of the second diameter, each configured to cooperate respectively with the bushings.

In a second embodiment, the support plate has a first and a second lug configured to cooperate respectively with caliper bushings of identical diameters, forming a sliding connection between the pad and the caliper, and the reinforced portion is an increase in the plate's dimensions near the second lug.

In this embodiment, the invention also relates to a caliper comprising two bushings of identical diameters connecting the caliper's two jaws; two pads with lugs configured to cooperate with the bushings; and a stop. The support plate has an asymmetric part configured to allow passage of the stop.

The invention also relates to a disc brake caliper equipped with a pad according to the aforementioned characteristics.

Finally, the invention relates to a disc brake receiving a caliper according to the aforementioned characteristics. Advantageously, the disc is made from carburizing steel, preferably 18NiCr5-4 or 16NC6. Choosing such a material for the disc makes it compatible with the pads according to the invention. Indeed, these pads enable better braking performance, generating significant heat briefly and repeatedly. Such temperature cycles represent quenching cycles for the disc, which may crack due to changes in its mechanical properties or thermal fatigue. Using carburizing steel helps to mitigate these issues.

### BRIEF DESCRIPTION OF THE DRAWINGS

FIG. 1 is a front view of a disc brake according to the invention.

FIG. 2 is a side view of such a brake.

FIG. 3 is an exploded view illustration of a brake caliper according to the invention.

FIG. 4 is a partial front view of such a caliper.

FIG. 5 is a perspective view of another caliper according to the invention.

FIG. 6 is a partial front view of such a caliper.

### DETAILED DESCRIPTION OF THE INVENTION

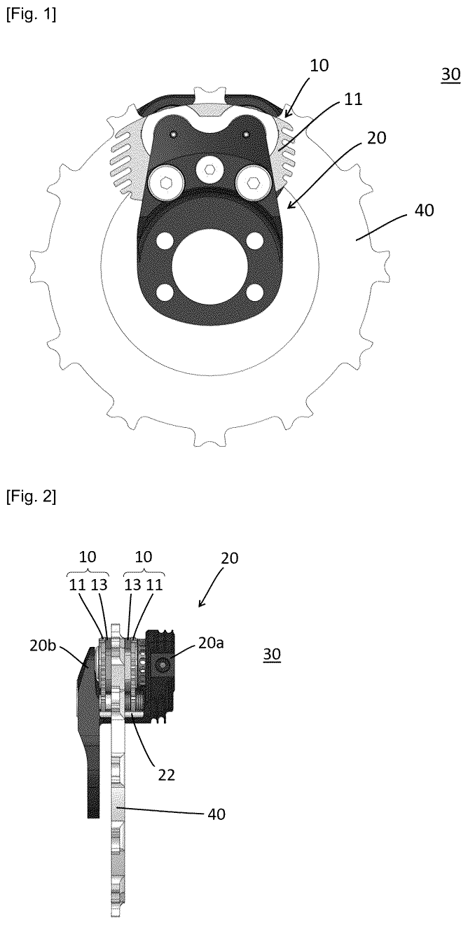

Referring to FIGS. 1 and 2, the invention lies in the choice of a particular alloy for creating a support plate (11) of a brake pad (10), intended to equip a caliper (20) of a disc brake (30). The alloy of the plate (11) is 15CDV6.

Compared to structural steel typically used for making plates (11), this choice results in a plate (11) that is stronger both thermally and mechanically. At high temperatures, the mechanical strength is significantly higher.

Tests conducted by the Applicant compared 15CDV6 steel to a known steel called “Imex700,” or S 690 QL according to the European standard EN 10025-6: March 2005, initially used for making the plate (11).

The tests involved bending tests on Imex700 and 15CDV6 specimens with identical dimensions, except for a thickness of 4 mm for Imex 700 and 3 mm for 15CDV6. During the bending test, the specimen is held horizontally at one end by a clamp, and a weight is suspended at the other end. A section near the clamp was reduced to ensure bending at that point. The distance between the free end of the specimen and the reduced section is 150 mm.

The specimen is first tested at 21° C. by suspending weights until plastic deformation of the reduced section occurs.

A new specimen is then tested by suspending weights and heating the reduced section to 600° C. The specimen is then air-cooled, and its straightness is checked to determine if the elastic limit was exceeded. The tests are repeated with different weights until finding the elastic-plastic deformation limit.

The test results are compiled in the table below, noting that the calculated induced stress was normalized to account for the thickness difference between the specimens.

TABLE 1

| | | | Induced | | |
|---|---|---|---|---|---|
| | Thickness | Bending | Stress | | |
| Steel | (mm) | Weight (kg) | (Mpa) | Twisted | Heated |
| 15CDV6 | 3 | 14.06 | 1970 | Yes | 21° C. |
| 15CDV6 | 3 | 7.02 | 984 | Yes | 600° C. |
| 15CDV6 | 3 | 5.6 | 785 | No | 600° C. |
| Imex700 | 4 | 17 | 1340 | Yes | 21° C. |
| Imex700 | 4 | 8.62 | 680 | Yes | 600° C. |
| Imex700 | 4 | 5.82 | 459 | No | 600° C. |

The results show that 15CDV6 withstands an induced stress of 785 Mpa when heated to 600° C., whereas Imex 700 only withstands 459 Mpa, making 15CDV6 70% more resistant than Imex700.

Since the plate (11) can withstand higher stresses, the pad (10) is more efficient, and the brake (30) is designed for greater braking efforts.

In this case, the pads (10) and the disc (40) heat up more during use, and during intensive use, they can reach high temperatures, above 700° C.

The high rotational speed of the disc (40) induces rapid cooling by convection, causing the disc (40) to undergo quenching cycles at regular intervals. Such abrupt temperature cycles involve thermal fatigue for the disc (40), making it brittle.

To mitigate this issue, the disc (40) is made from non-quenching steel, such as carburizing steel, containing less than 0.3% carbon. Such a disc (40) is less sensitive to the temperature cycles obtained with the improved pad (10) according to the invention.

Therefore, it is possible to design a lighter pad (10), notably by reducing the thickness of the plate (11). For example, it can be between 2 mm and 6 mm thick. In practice, it is possible to increase performance with the same plate thickness or reduce the plate thickness while maintaining performance. For example, the plate can be reduced from 6 mm to 4.5 mm in thickness, keeping the same performance.

To prevent a reduced thickness from weakening the kinematic connection surfaces of the pad (10) with the caliper (20), these connection means include a reinforced portion (19).

However, the direction of significant braking is always the same, that of the vehicle's advance: it is therefore not wise to reinforce all the kinematic connection means, but only the surfaces that oppose significant braking forces.

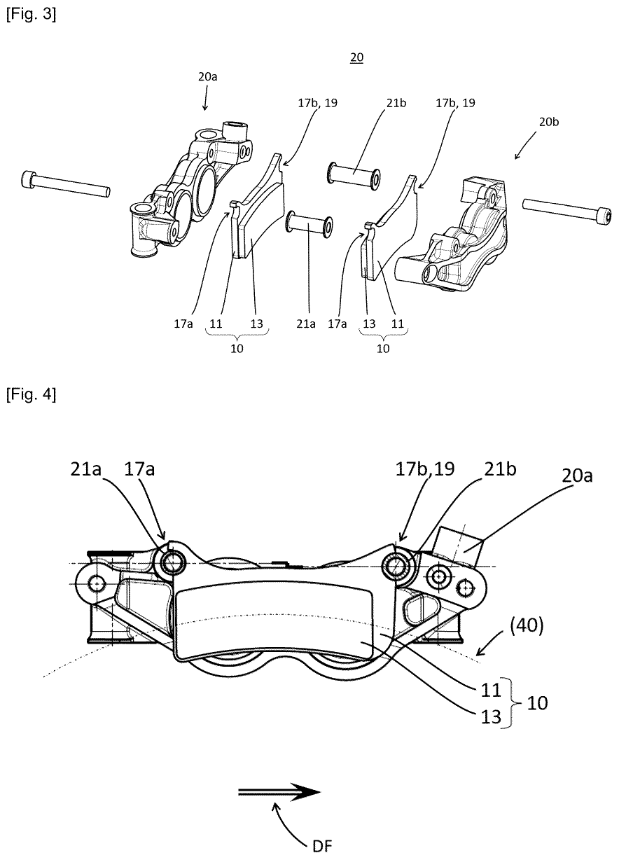

The pad (10) is, in the illustrated embodiment, asymmetric: only one reinforced portion (19) is present, arranged to hold the pad (10) in the braking direction (DF) shown in FIGS. 3 and 6. As the pads (10) are asymmetric, care must be taken not to mount them incorrectly on the caliper (20). Therefore, there are preventing means.

FIGS. 3 and 4 illustrate a first embodiment, in which:
The preventing means are a difference between a first mounting diameter and a second mounting diameter;
The reinforced portion (19) is the second diameter, which is larger than the first diameter.

More specifically, the support plate (11) has a first lug (17a) of the first diameter and a second lug (17b) of the second diameter, with each lug (17a, 17b) configured to cooperate respectively with a first bushing (21a) of the first diameter and a second bushing (21b) of the second diameter, connecting the calipers jaws (20a, 20b) and forming a sliding connection between the pad (10) and the caliper (20).

Since the second diameter is larger than the first diameter, the surface of the connection withstanding significant braking forces is larger. Conversely, the contact pressure is lower, preventing deformation of this surface.

However, keeping a smaller first diameter allows for a lighter first bushing.

To prevent the first bushing (21a) and the second bushing (21b) from being swapped in the caliper (20), their installation also includes preventing means. For example, the first bushing (21a) has a first length, and the second bushing (21b) has a different length.

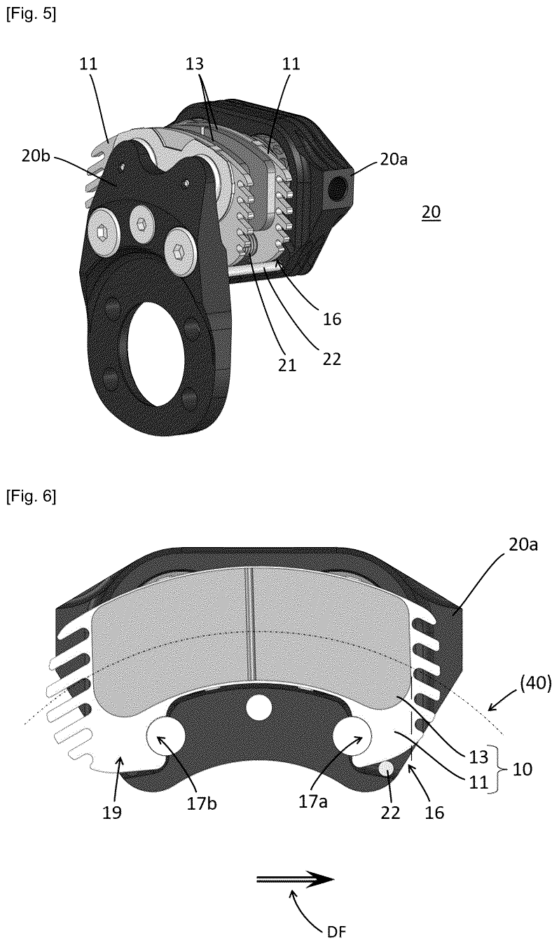

FIGS. 5 and 6 illustrate a second embodiment in which:
The preventing means are an asymmetry of the plate (11), allowing a passage (16) for a caliper stop (22);
The reinforced portion (19) is an enlargement of the plate (11) on the side opposite the passage (16).

The passage (16), in the illustrated embodiment in the form of a bevel, ensures that the stop (22) only allows the pad (10) to be mounted in one direction. This passage (16) is provided on the side of a first lug (17a) of the plate (11), which does not withstand significant braking forces due to the pad's (10) mounting direction.

The reinforced portion (19) is placed on the side of a second lug (17b) of the plate, which withstands significant braking forces due to its mounting direction.

The reinforced portion (19), in the form of an enlargement of the dimensions, increases the quadratic moment of the plate (11) locally, preventing deformation under load. On the side of the first lug (17a), it is unnecessary to increase the quadratic moment, so the plate's dimensions are reduced.

In this embodiment, the two bushings (21) connecting the caliper's jaws (20a, 20b) have identical diameters.

The caliper (20) itself has its own preventing means to avoid incorrect installation on the vehicle.

Furthermore, the pad (10), caliper (20), and brake (30) can be configured differently from the given examples without departing from the invention's scope, which is defined by the claims.

Additionally, the technical features of the different embodiments and variants mentioned above can be combined, in whole or in part. Thus, the pad (10), caliper (20), and brake (30) can be adapted in terms of cost, functionality, and performance.

1. Brake pad for a disc brake caliper, comprising a support plate receiving a friction material, characterized in that the support plate is made from steel containing less than 0.3% by weight of carbon and vanadium in an amount between 0.2 and 0.3% by weight.

2. Brake pad according to claim 1, characterized in that the support plate is made from 15CDV6 steel.

3. Brake pad according to claim 1, characterized in that the support plate has a thickness between 2 mm and 6 mm.

4. Brake pad according to claim 1, characterized in that the support plate includes kinematic connection means with a caliper, and part of these connection means is configured to withstand higher mechanical forces than the rest of the connection means, forming a reinforced portion.

5. Brake pad according to claim 4, characterized in that the support plate has a first lug of a first diameter and a second lug of a larger diameter, with each lug configured to cooperate respectively with a first bushing and a second bushing of a caliper, forming a sliding connection between the brake pad and the caliper, and the reinforced portion is the second lug.

6. Brake pad according to claim 4, characterized in that the support plate has a first and a second lug configured to cooperate respectively with caliper bushings of identical diameters, forming a sliding connection between the brake pad and the caliper, and the reinforced portion is an enlargement of the plate near the second lug.

7. Caliper for a disc brake having one or more caliper jaws each equipped with a pad said pad comprising a support plate receiving a friction material, characterized in that the support plate is made from steel containing less than 0.3% by weight of carbon and vanadium in an amount between 0.2 and 0.3% by weight.

8. Caliper according to claim 7, characterized in that it includes a first bushing of a first diameter and length, and a second bushing of a different diameter and length, connecting the caliper's jaws, with the caliper receiving brake pads featuring a support plate with a first lug of the first diameter and a second lug of the second diameter, each configured to cooperate respectively with the bushings.

9. Caliper according to claim 7, characterized in that it includes:
Two bushings of identical diameters connecting the caliper's jaws;
Two pads with lugs configured to cooperate with the bushings; and
A stop;
with the support plate having an asymmetric part configured to allow passage of the stop.

10. Disc brake configured to receive a caliper according to claim 7, comprising a disc made from carburizing steel, preferably 18NiCr5-4 or 16NC6.

11. Disc brake configured to receive a caliper according to claim 8, comprising a disc made from carburizing steel, preferably 18NiCr5-4 or 16NC6.

12. Disc brake configured to receive a caliper according to claim 9, comprising a disc made from carburizing steel, preferably 18NiCr5-4 or 16NC6.
